(19) United States
(12) Patent Application Publication
(10) Pub. No.: US 2008/0012332 A1
(43) Pub. Date: Jan. 17, 2008

(54) Pipe coupling adapter

(76) Inventor: Jeff Hunt, Bend, OR (US)

Correspondence Address: GLENN C. BROWN, PC, 777 NW WALL STREET, SUITE 308, BEND, OR, 97701, US

(21) Appl. No.: 11/347,473

(22) Filed: Feb. 3, 2006

(51) Int. Cl. F16L 15/00

(52) U.S. Cl. 285/390

(57) ABSTRACT

A method for tightening a pipe coupler includes the steps of attaching a first end of the pipe coupler to a pipe, attaching an adapter to a second end of the pipe coupler, attaching an air gun to the adapter, tightening the pipe coupler by operating the air gun, and, after the tightening, removing the adapter from the pipe coupler. Threaded portions of the pipe and the pipe coupler are tapered, while the threaded portion of the adapter is not tapered. In an alternate embodiment, the adapter comprises a baffle and a ball on an inner surface.

### BACKGROUND OF THE INVENTION

1. Technical Field

The present invention relates to a threaded adapter which is removeably attached to a pipe coupler to facilitate tightening of the coupler.

2. Field of the Invention

In order to attach a pipe coupler to a pipe, the threaded coupler is manually screwed on to the end of the pipe and then the coupler is tightened using a pipe wrench.

This process takes up a lot of time and energy. There is a need for an easier method for tightening pipe couplers.

### BRIEF SUMMARY OF THE INVENTION

An object of the present invention is to provide a method and apparatus for quickly and easily tightening pipe couplers.

An advantage of the present invention is that it greatly reduces the time and energy required to tighten pipe couplers. For example, the process of tightening all of the pipe couplers for a large project that would take three hours with a pipe wrench can be reduced to twenty minutes using the adapter of the present invention.

The above objects and advantages are accomplished by providing a threaded adapter that is temporarily attached to a pipe coupler. After attaching the adapter, an air gun is used to tighten the pipe coupler. After achieving the necessary tightness in the pipe coupler, the adapter is removed.

### BRIEF DESCRIPTION OF THE DRAWINGS

The nature, principle and utility of the present invention will be clearly understood from the following detailed description when read in conjunction with the accompanying drawings, wherein:

FIG. 1 is a cross-sectional view of a first embodiment of the adapter.

FIG. 2 is a cross-sectional view of a second embodiment of the adapter.

FIG. 3 is a front sectional view along line 3-3 in FIG. 2.

FIGS. 4-8 depict the method for tightening the pipe coupler using the adapter.

The drawings are for illustrative purposes only and are not drawn to scale. In the drawings, the same numbers are used for the same part or portion throughout the drawings.

### DETAILED DESCRIPTION OF THE INVENTION

FIG. 1 shows a cross-sectional view of the adapter 10. The adapter 10 includes a threaded end 12, a lip 14 and a second end 16. The cavity 18 in the second end 16 of the adapter 10 facilitates attachment of the air gun during the pipe coupler tightening process. The adapter 10 is preferably made of a non-corrosive metal, but may also be made of other suitable materials such as PVC or other high-strength polymers.

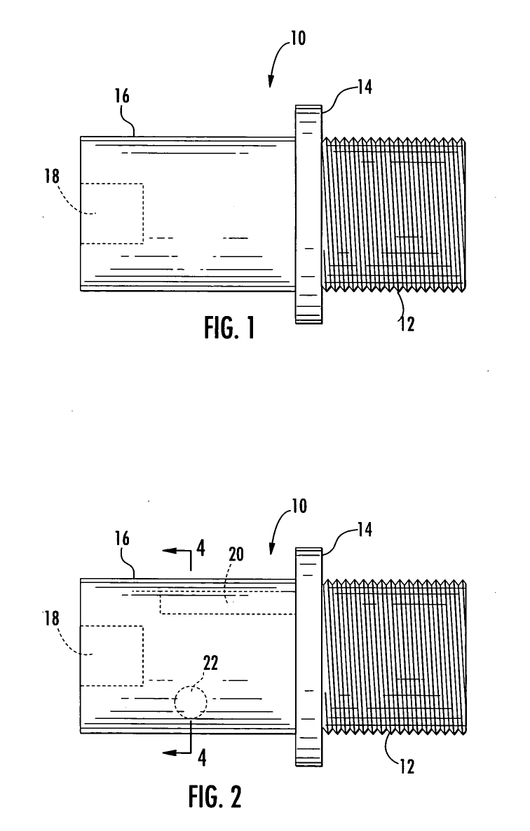

An alternate embodiment of the adapter 10 is shown in FIGS. 2 and 3, where FIG. 3 is a front sectional view along line 3-3 of FIG. 2. In this alternate embodiment, the adapter 10 includes a baffle 20 and a ball 22. As the adapter 10 is rotated during the tightening process, the baffle 20 causes the ball 22 to rotate along the inner surface of the hollow adapter. The baffle 20 and ball 22 arrangement may provide additional inertia during the tightening process.

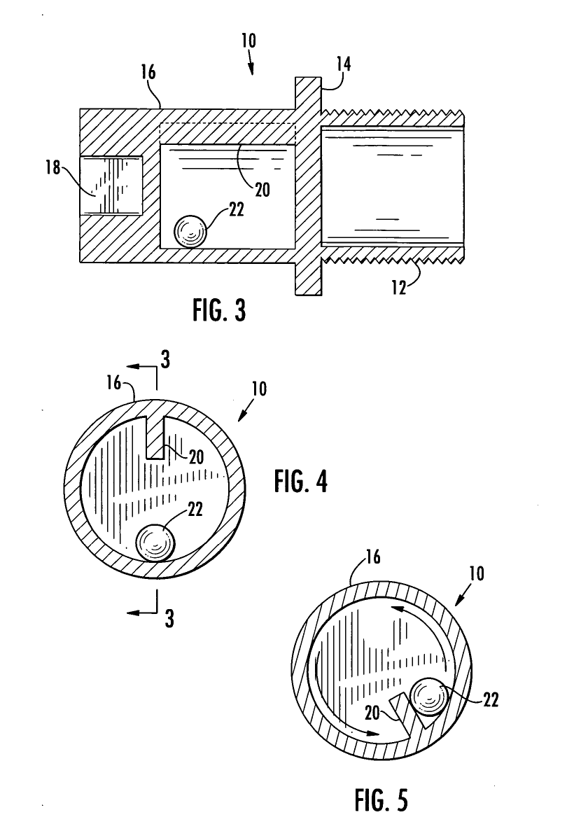

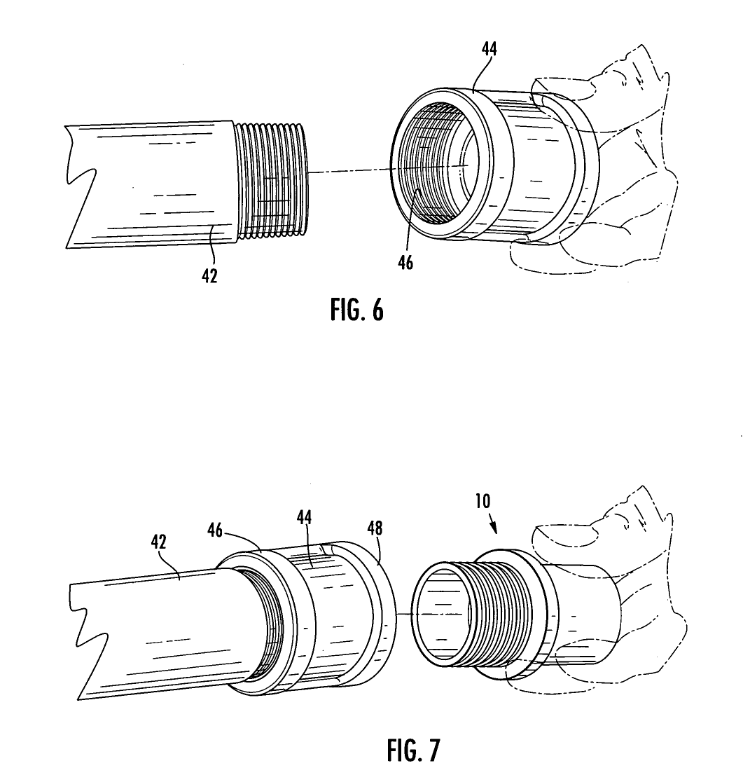

The method for tightening a pipe coupler using the adapter is discussed in more detail in reference to FIGS. 4-8. FIG. 4 depicts the distal end of a pipe 42 and a pipe coupler 44. The threaded portions of the pipe 42 and the pipe coupler 44 are tapered in order to achieve adequate tightness between the pipe 42 and the coupler 44. However, the threaded end 12 of the adapter is not tapered so that when the adapter 10 is attached to the coupler 44, the attachment is not too tight and the adapter is removed easily.

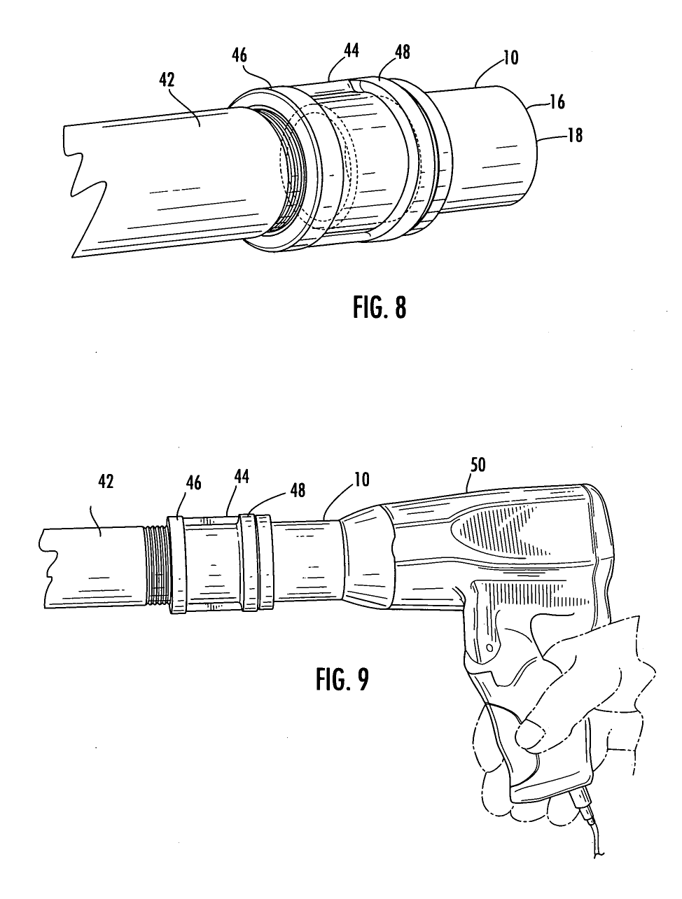

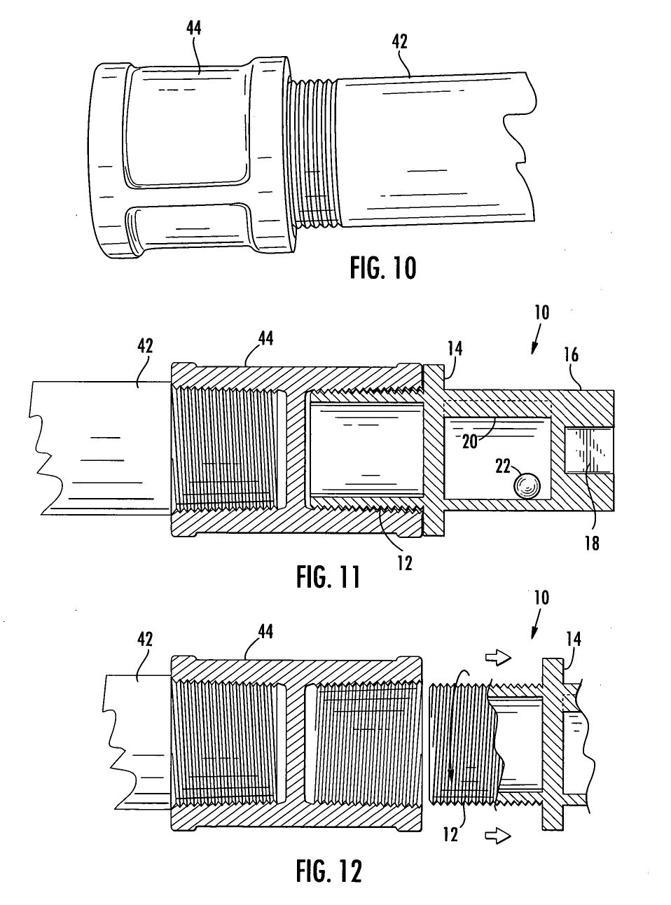

Once a first end 46 of the coupler 44 is loosely attached to the pipe 42, as shown in FIG. 5, the adapter 10 is attached to the second end 48 of the coupler 44, as shown in FIG. 6. An air gun 50 is then inserted into the cavity 18 in the second end 16 of the adapter 10, as shown in FIG. 7. Operating the air gun 50 causes the adapter 10 to rotate, which in turn causes the coupler 44 to rotate and tighten. Upon achieving the desired tightness, the air gun 50 and the adapter 10 are removed, as shown in FIG. 8.

While the invention has been described by reference to the preferred embodiments described above those skilled in the art will recognize that the invention as described and illustrated can be modified in arrangement and detail without departing from the scope of the invention.

What is claimed is:

1. A pipe coupler system comprising:
a pipe with a protruding threaded end;
a pipe coupler comprising a first end and a second end, wherein the first end of the pipe coupler is attached to the threaded end of the pipe; and
an adapter comprising a protruding threaded end and a second end,
wherein the protruding threaded end of the adapter is attached to the second end of the pipe coupler, and
wherein the second end of the adapter comprises a cavity.

2. The pipe coupler system according to claim 1, wherein the cavity is adapted to receive an air gun.

3. The pipe coupler system according to claim 1, wherein the protruding threaded end of the pipe comprises tapered threads and wherein the protruding threaded end of the adapter comprises threads that are not tapered.

4. The pipe coupler system according to claim 1, wherein an inner surface of the adapter comprises a baffle and a ball.

5. A method for tightening a pipe coupler comprising:
attaching a first end of the pipe coupler to a pipe;
attaching an adapter to a second end of the pipe coupler;
attaching an air gun to the adapter;
tightening the pipe coupler by operating the air gun; and
after the tightening, removing the adapter from the pipe coupler.

6. The method according to claim 5, wherein the first end and the second end of the pipe coupler comprise threaded portions, wherein the threaded portions are tapered.

7. The method according to claim 6, wherein the adapter comprises a threaded portion, wherein the threaded portion of the adapter is not tapered.

8. The method according to claim 5, wherein an inner surface of the adapter comprises a baffle and a ball.
